(19) United States
(12) Patent Application Publication
(10) Pub. No.: US 2023/0079229 A1
(43) Pub. Date: Mar. 16, 2023

(54) POWER MODULATION USING DYNAMIC VOLTAGE AND FREQUENCY SCALING

(71) Applicant: Maxim Integrated Products, Inc., San Jose, CA (US)

(72) Inventors: Mark Alan LOVELL, Lucas, TX (US); Robert Michael MUCHSEL, Addison, TX (US)

(73) Assignee: Maxim Integrated Products, Inc., San Jose, CA (US)

(21) Appl. No.: 17/472,113

(22) Filed: Sep. 10, 2021

(51) Int. Cl. G06N 3/063; G06N 3/04; G06F 11/14

(52) U.S. Cl. CPC G06N 3/0635; G06N 3/0472; G06F 11/1476

(57) ABSTRACT

Non-intrusive, low-cost systems and methods allow designers to reduce headroom and safety margin requirements in the context of compute circuits, such as machine learning circuits, without increasing footprint or having to sacrifice computing capacity and other valuable resources. Various embodiments accomplish this by taking advantage of certain properties of machine learning circuits and using a CNN as a diagnostic tool for evaluating circuit behavior and adjusting circuit parameters to fully exploit available computing resources.

### BACKGROUND

### A. Technical Field

The present disclosure relates generally to data processing in machine-learning applications. More particularly, the present disclosure relates to power control systems and methods for efficiently using machine learning compute circuits that perform large numbers of arithmetic operations.

### B. Background

Machine learning is a subfield of artificial intelligence that enables computers to learn by example without being explicitly programmed in a conventional sense. Numerous machine learning applications utilize Convolutional Neural Networks (CNNs) that are supervised networks capable of solving complex image classification and semantic segmentation tasks. A CNN uses as input large amounts of multi-dimensional training data, e.g., image or sensor data, to learn prominent features therein by using and reusing filters with learnable parameters that are applied to the input data. In a subsequent inference phase, the CNN uses unsupervised operations to detect or interpolate previously unseen features or events in new input data to classify objects or to compute an output such as a regression, or to combine its output with the input for tasks such as noise suppression.

To perform large numbers of arithmetic computations for convolutions, oftentimes, hardware accelerators, such as embedded hardware machine learning accelerators, are used. The power consumption demands of such devices vary over a wide dynamic range that is highly dependent on various factors such as the topology of the system the accelerator operates in, the size of the CNN that is being processed and number of convolutional computations performed, the type and dimensions of data being processed, the clock speed at which computation are performed, and the like.

Internal and external power supplies, such as linear regulators or switching power supplies, commonly used to drive power-hungry hardware accelerators are dimensioned to output power on one or more fixed rail voltages. Since hardware accelerators have to perform a large number of computations in a relatively short amount of time, this oftentimes results in undesirable instantaneous current and power spikes that tend to negatively impact the lifetime of the computing hardware.

While some approaches are equipped to reduce power by setting at least some portions of a circuit into low-power mode, e.g., a sleep mode, all available power rails typically continue to operate at their nominal output voltage, i.e., at full capacity. Therefore, existing approaches cannot take advantage of lower memory supply voltages and other features presented herein that use system knowledge to intelligently reduce overall power consumption. Unlike approaches that lack contextual awareness of the type and intensity of computation steps that hardware accelerators and similar compute circuits are performing at any moment in time, and the power demands of each set of operations, certain embodiments herein proactively adjust power-related parameters in a way that benefits the machine learning circuit and avoids wasting valuable power resources, especially in embedded systems.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 is a general illustration of a conventional embedded machine learning accelerator system.

FIG. 2 illustrates an exemplary block diagram of a control system for increasing computing resource utilization in machine learning circuits according to various embodiments of the present disclosure.

FIG. 3 is a flowchart of an illustrative process for increasing computing resource utilization in CNNs according to various embodiments of the present disclosure.

FIG. 4 is a flowchart of an alternative process for increasing computing resource utilization in CNNs according to various embodiments of the present disclosure.

FIG. 5 depicts a simplified block diagram of a computing device/information handling system, in accordance with embodiments of the present disclosure.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. The words “optimal,” “optimize,” “optimization,” and the like refer to an improvement of an outcome or a process and do not require that the specified outcome or process has achieved an “optimal” or peak state. In this document the terms “include,” “including,” “comprise,” and “comprising” shall be understood to be open terms and any lists the follow are examples and not meant to be limited to the listed items. The terms “memory,” “memory device,” and “register” are used interchangeably. Similarly, the terms kernel, filter, weight, parameter, and weight parameter are used interchangeably. The term “layer” refers to a neural network layer. “Neural network” includes any neural network known in the art. “Hardware accelerator” refers to any electrical or optical circuit that may be used to perform mathematical operations and related functions, including auxiliary control functions. “Circuit” includes “sub-circuits” and may refer to both custom circuits, such as special hardware, and general purpose circuits. The terms “computing performance” and “circuit performance” refer to computing speed, network capacity, data processing efficiency, power efficiency and similar parameters (and metrics for measuring performance and computing resources) in computing systems and other electrical circuits. The terms “safety margin,” “margin,” “error margin,” and “headroom” are used interchangeably.

It is noted that although embodiments described herein are given in the context of CNNs, one skilled in the art shall recognize that the teachings of the present disclosure are not so limited and may equally increasing computing resource utilization in other computing systems and circuits.

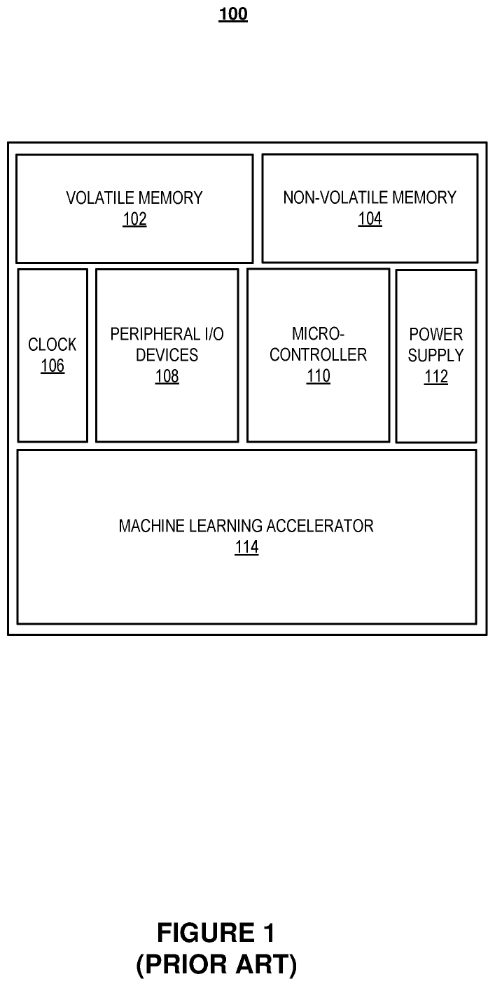

FIG. 1 illustrates a conventional embedded machine learning accelerator system that processes data in multiple stages. System 100 contains volatile memory 102, non-volatile memory 104, clock 106, clock I/O peripherals, microcontroller 110, power supply 112, and machine learning accelerator 114. Microcontroller 110 can be a traditional DSP or general-purpose computing device, machine learning accelerator 114 can be implemented as a CNN accelerator that comprises hundreds of registers (not shown). As depicted in FIG. 1, machine learning accelerator 114 interfaces with other parts of embedded machine learning accelerator system 100.

In operation, microcontroller 110 performs arithmetic operations for convolutions in software, or using one or more hardware accelerators. Machine learning accelerator 114 typically uses weight data to perform matrix-multiplications and related convolution computations on input data using weight data. The weight data may be unloaded from accelerator 114, for example, to load new or different weight data prior to accelerator 114 performing a new set of operations using the new set weight data. More commonly, the weight data remains unchanged, and for each new computation, new input data is loaded into accelerator 114 to perform the computations. Machine learning accelerator 114 oftentimes performs millions of computations in a short time, which can cause power supply 112 to encounter power spikes, e.g., in the form of current spikes, that adversely impact the long-term performance of system 100, or cause the system to fail unless power supply 112 and its support circuitry is designed to handle the fastest rise in power demand under all environmental conditions (e.g., higher summer temperatures) system 100 may encounter over its lifetime.

As the amount of data subject to convolution operations increases and the complexity of operations continues to grow, so does power consumption. One of the shortcomings of power supply 112 is that it lacks any feedback mechanisms to utilize information about machine learning accelerator 114 to adapt to high and low-power operations. Thus, power supply 112 in unable to control power based on the actual power needs of the computing resources of system 100 to reduce power consumption. Accordingly, what is needed are systems and methods that allow hardware accelerators to efficiently process large amounts of complex arithmetic operations for neural networks with low power consumption and, ideally, without increasing hardware cost.

In general, depending on the use case, electronic devices are designed to operate under a number of different circumstances and endure varying environmental effects such as temperature swings. Even if rare in practice, electronic devices are ideally designed to operate even under “worst case” conditions. In addition, statistically, the worst performing circuit component or sub-circuit usually dominates the overall performance of an electronic circuit. Therefore, circuit design that achieves desired specifications, while keeping the likelihood of circuit failures low, must take into account a wide range of possible scenarios, including effects such as wafer-to-wafer (and even inter-chip) deviations.

In practice, this requires setting relatively conservative safety margins (margins of 20% and more are not untypical) to circuit parameters to compensate for expected and unexpected variations. However, design constraints, such as mandatory safety margin requirements, result in mostly derated circuits that leave significant available computing capacity unutilized. For example, as power increases quadratically with voltage, adding headroom to an IC's supply voltage results in undesirable higher power dissipation, thus, reducing overall circuit efficiency. Therefore, in most cases far-reaching tradeoffs between designing for the worst-case and achieving desired circuit performance must be made.

There exist numerous design techniques for building headroom into circuits to account for at least some of the worst case scenarios and to compensate for fabrication-related component variations while striving for good circuit performance. One technique, dynamic voltage scaling, involves using a self-test circuit to detect a failure once a voltage applied to the test circuit becomes too low. For example, measuring the minimum core supply voltage at which the circuit will maintain its functionality can assist in determining how close the voltage can be set to a borderline condition (e.g., the nominal minimum voltage to which a safety margin is added) that yields energy savings while ensuring reliable operation.

However, such approaches control physical parameters and environmental conditions, such as temperature, voltage, current, etc., which are measured, e.g., at a limited number of measurement points on or near the circuit and indexed in look-up tables. Therefore, existing techniques do not lend themselves to software and machine learning applications.

In addition, such methods are bound to choose relatively conservative design constrains due to the inability of the designer to know all the circumstances that a user is going to expose the circuit to, leading to the design of relatively large safety margins that cover a wide range of possible scenarios. Further, indirect testing and measuring makes not only troubleshooting problem areas more difficult but also does not allow designers to fully exploit available computing resources as indirectly obtained parameters merely serve as proxies that can only roughly approximate how, e.g., a microcontroller or machine learning hardware, such as a CNN circuit that ultimately performs calculations that deliver a desired output, would behave under certain conditions.

For example, certain areas of interest, such as hot spots on a die, are covered by logic circuitry and, thus, not accessible to allow exact measurements from which reliable conclusions regarding headroom may be drawn to guarantee that a circuit reliably operates without fail. Furthermore, the implementation of measurement circuitry requires additional die space for several circuit components that each have their own headroom and headroom requirements, thus, partially defeating their own purpose.

In contrast, CNN applications and their use cases are, advantageously, much more straightforward and predictable allowing for a much better approximation of actual circuit/operating conditions. Various embodiments herein provide non-intrusive, low-cost systems and methods that allow designers to build in headroom and safety margins that account for worst case scenarios in the context of machine learning without having to sacrifice computing capacity or other valuable resources. A low-cost controller or logic whose size is relatively small compared to the machine learning hardware itself saves die space as no additional space is required for circuitry whose only purpose is to take measurements. In various embodiments a testing network utilizes the actual output(s) of a machine learning circuit and to take advantage of certain properties of machine learning circuits to fully exploit available computing resources.

In detail, one known property of machine learning circuits is that, given a known input at a known network of certain complexity, a relatively small change in the chain of events is generally amplified to a relatively large change at the output. As a result, one may readily detect potential problems along a logic chain or computational path. For comparison, this amplification is not as drastic as the known property of encryption schemes in encryption applications where, on average, a single bit being flipped at the input of an encryption algorithm results in half of the bits at the output also being flipped.

Various embodiments herein use some of all of a machine learning circuit itself as a diagnostic tool to evaluate circuit behavior and adjust operational parameters of an electric circuit to, ultimately, optimize power supply resource utilization to increase computing efficiency. A machine learning circuit, e.g., a CNN, will change behavior during operation if at least some part of the circuit on which the CNN operates exceeds a critical temperature or operates too fast. In such cases, the CNN may not operate as expected and output in an incorrect result that is observable or measureable. Various embodiments take advantage of this by using a known input, such as a test pattern or test program, to test the CNNs' behavior and control one or more operational parameters (e.g., clock speed) to lower a safety margin (e.g., to a lower clock speed as little as small as practically possible), thereby, increasing overall computing capacity.

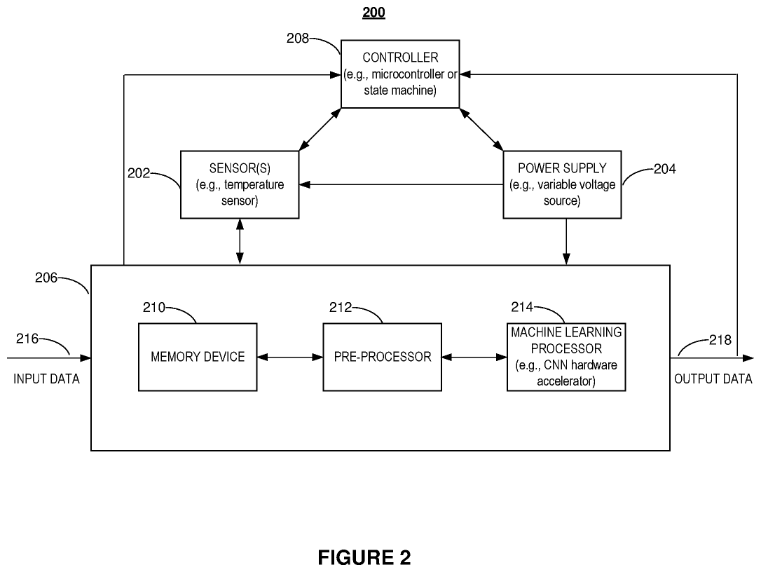

As discussed below with reference to FIG. 2, in embodiments, to determine one or more suitable circuit parameters to achieve a lower error margin, e.g., to operate the CNN as close to the edge as possible, a control circuit may take into consideration that some ICs may operate faster than other ICs, or even that one part of an IC may operate faster than another part of the same IC.

FIG. 2 illustrates an exemplary block diagram of a control system for increasing computing resource utilization in machine learning circuits according to various embodiments of the present disclosure. As depicted, control system 200 may comprise controller 208, power supply 204, sensors 202, e.g., on-device temperature sensors, and circuit 206 that, in embodiments, may comprise memory device 210, pre-processor 212, and machine learning processor 214. A person of skill in the art will appreciate that one more components in FIG. 2 may be disposed on an ASIC, an IC, a semiconductor chip, etc.

In embodiments, controller 208 may be implemented comprising a microcontroller or state machine, a comparator (not shown), and any number of control circuit elements known in the art, such as logic circuits, converters, amplifiers, and memory that may store (e.g., in a one-time programmable memory) measured, sensed, and calculated information, such as circuit configuration parameters for machine learning processor 214. Machine learning processor 214 in circuit 206 may be implemented, e.g., as a machine learning hardware accelerator that operates any portion of a CNN, which may undergo a training process to perform one or more tasks. Power supply 204 may comprise any combination of external and internal power supplies to provide power to a number of circuit components. On-device sensors 202 may comprise circuitry for monitoring and/or measuring parameters associated with control system 200. Exemplary parameters include hardware-related parameters, such as current or voltage and environmental parameters, e.g., temperature. Timing-related parameters may include clock cycles, processing times, and the like. It is noted that sub-circuits within control system 200 may each comprise their own set of sensors 202 and associated monitoring circuitry.

In operation, controller 208 may facilitate proper communication within control system 200 and beyond. In embodiments, controller 208 may implement a power management scheme that takes into account information about measured or modeled data related to circuit 206 and its operation, e.g., operational and/or configuration data related to machine learning processor 214 to dynamically decrease a headroom requirement by adjusting operational parameters. In embodiments, controller 208 may decrease headroom by causing power supply 204 to reduce a power supply voltage or by reducing a variable clock speed achieve a high degree of computing resource utilization, ideally, while meeting circuit specifications despite changing circuit and environmental conditions.

In embodiments, controller 208 may directly or indirectly control circuit 206, for example, to begin operating at an initial power supply voltage at which known input data 216 may be applied to at least a portion of a CNN or a dedicated testing network to generate output 218, which may be an inference result or some other circuit response. The initial voltage may have been chosen to satisfy a headroom requirement or safety margin intended to ensure the proper functioning of circuit 206, especially, that of machine learning processor 214. Input data 216 may comprise a test pattern or other test data that may be used to verify that circuit 206 is operational at a certain setting or parameter. In embodiments, once machine learning processor 214 generates the inference result at output 218, controller 208 may compare that result or its validity to a corresponding reference result to determine whether machine learning processor 214 or any part of circuit 206 operates as expected, e.g., whether the test pattern produces a satisfactory result according to a design specification.

In embodiments, once controller 208 determines that circuit 206 functions properly at that the initial power supply voltage, controller 208 may instruct power supply 204 to output a lower voltage, thereby, decreasing a headroom or safety margin in exchange of increasing circuit efficiency. Advantageously, in many applications, drawing less power extends battery life time, increases MTBF, and has various other desirable properties resulting from decreased power and power density on a chip.

In embodiments, controller 208 may cause power supply 204 to lower its output voltage(s) in an iterative manner, e.g., in a number of predetermined increments using various statistical methods known in the art. In embodiments, controller 208 may reload the same or different input data and repeat the test(s), e.g., until the CNN, which in effect resembles a canary circuit, no longer generates a satisfactory result. Stated differently, to conserve power, a voltage may be lowered during a testing phase to ascertain, e.g., in a pass/fail fashion, the lowest acceptable operating voltage or highest acceptable clock speed that still returns correct test results.

In embodiments, the CNN may use a set of parameters that are identical or substantially equal to those that machine learning processor 214 would use in an actual inference during regular operation. In this way, unlike in existing dynamic voltage scaling methods that merely use a representation of logic that is not necessarily present in the microcontroller itself, various embodiments herein use known test data on the CNN itself combined with operational parameters to emulate real word conditions that are practically identical to those when circuit 206 operates during regular operation, i.e., using network parameters that the CNN would use when performing an actual inference operation.

A person of skill in the art will appreciate that testing may comprise accelerated testing, reliability testing, and other methods and that, for a given circuit, to account for relatively slow drifts that may occur over a period of time, tests may be automatically performed in periodic or random intervals, for example, in the background and/or when machine learning processor 214 is not in use.

In embodiments, once controller 208 detects a result that is deemed unacceptable, e.g., when machine learning processor 214 generates an inference that result deviates from an expected result by some amount that is indicative of a malfunction of one or more components in circuit 206, controller 208 may instruct power supply to revert an output voltage, frequency, etc., to a proper modified value that did not cause an erroneous result or a failure of the CNN. In embodiments, controller 208 may add to that modified value a safety margin to obtain an operating voltage that both satisfies a headroom specification and increases circuit efficiency, e.g., of the CNN, when operating that voltage, which is lower than the initial voltage.

In embodiments, the added safety margin, which may be programmable, may comprise at least one component that is circuit specific such as to account for the unique characteristics of at least some part of circuit 206. Another part of the added safety margin may take into account noise (e.g., switching noise and other uncertainties) and other dynamic or fixed variables (e.g., circuit impedance) that may be characterized and factored into, e.g., an error or margin calculation, which, in embodiments, may use statistical sampling of a number devices and the application of a suitable statistical distribution model that satisfies one or more circuit specifications. In general, the added safety margin should be as small as possible, yet sufficient to ensure reliable operation.

In embodiments, controller 208 may reduce or minimize the number of iterations to determine or zero in on operating voltage by using one set of parameters and use a set different set of parameters to account for changes in circuit characteristics (e.g., temperature shifts), states (e.g., transitions form a sleep state), temporal changes, and in response to detecting other variations.

In embodiments, controller 208 may obtain inference results relatively quickly and frequently and use that information, e.g., to track environmental conditions. Then, based on the information, the control circuit may swiftly adjust any relevant parameter to adjust an error margin. In embodiments, controller 208 may use the longest chain of logic or a dominant path as a testing network. In embodiments, controller 208 may, advantageously, use the CNN itself as the longest path in the design to obtain more accurate test results. In this manner, both voltage and margin may be dynamically adjusted to the lowest levels that allow circuit 206 or any sub-circuit to physically function, while still satisfying rise times and other design parameters.

A person of skill in the art will appreciate that although the longest path(s) for each individual part or device is constant, since path lengths are subject to change due to differences in fabrication, e.g., depending where each device was located on a wafer or lot during the fabrication process, thus, causing a distribution of chip-to-chip variations. Therefore, in embodiments, each circuit 206 may be individually tested to eliminate the effects of device variability on the results, thus, allowing a further reduction in headroom and improved circuit efficiency.

Conversely, in embodiments, controller 208 may adjust circuit parameters, such as power output, processing speed, or other performance metrics, to take advantage of variations in circuit 206 that may have been caused by fabrication differences or environmental factors that may allow exploiting underutilized capacities in some devices. Once margins for circuit 206 have been determined, e.g., for a broad range of voltages, circuit 206 may commence performing regular inference operations on not previously “seen” input data 216.

Various embodiments take advantage of the fact that many functions of a machine learning processor 214 are highly deterministic to anticipate energy needs for some or all of circuit 206 for a given time period and control power supply 204 in a manner such as to optimize output power, e.g., by adjusting a power supply voltage, based on actual energy needs. In embodiments, controller 208 may, based on predetermined parameters and instantaneous data, such as type of operation and number of expected or calculated computations, anticipate energy demand for any part of circuit 206 and adjust parameters, such as power supply voltage and output current for any number of power supplies in an energy-efficient way, e.g., to lower a headroom or safety margin of components in control system 200.

As an example, given a trained neural network model, the occurrence of certain types of computational operations, such as a sum-of-products or multiplication operations, are relatively easily predictable since read/write and memory access operations associated therewith are relatively easily determined. As a result, for a given architecture, power consumption of circuit 206 may be relatively accurately estimated, i.e., power consumption may be predetermined for a given number of operations.

In embodiments, controller 208 may utilize such pre-determinable network-related and/or hardware-related information to estimate and adjust margins, such as supply voltage margins, to optimize power savings when circumstances allow to do so. Similarly, controller 208 may utilize hardware-related data, such as clock frequency, input and output currents or voltages that may be obtained or retrieved from other available sources, and fed back to controller 208 to enable controller 208 to adjust margins, e.g., based on estimated voltages. It is understood that controller 208 may advantageously combine estimated margins with empirically determined margins to arrive at ultimate operating margins

It is noted that controller 208 may manipulate any type of other and/or additional metric to control resource utilization, including one or more machine learning configuration parameters. Exemplary metrics may comprise quantitative and/or qualitative, local or global metrics and may include operational parameters such as data-related parameters, e.g., a number of read, write, store, and retrieve operations, steps in a calculation, etc.; timing-related parameters, such as clock cycles, processing times; environmental parameters, such as temperature data. Computational parameters may comprise the type of mathematical operations; type or dimensions of data being processed, and the like. In addition, any number of metrics may be obtained, measured, or derived directly from any computational unit or any auxiliary device, such as sensor 202, or indirectly from sources internal or external to system 200. A person of skill in the art will appreciate that circuit-related data may comprise instantaneous, averaged, or otherwise manipulated data. In embodiments, any number of metrics may be used to calculate a headroom, e.g., by using a formula that has been derived empirically or by an algorithm.

One of skill in the art will appreciate that variously embodiments may take advantage of any known resource utilization methods to increase efficiency, speed, and other circuit characteristics. As an example, power supply 204 may be controlled to operate in a standby mode to lower power consumption and increase power saving features of control system 200.

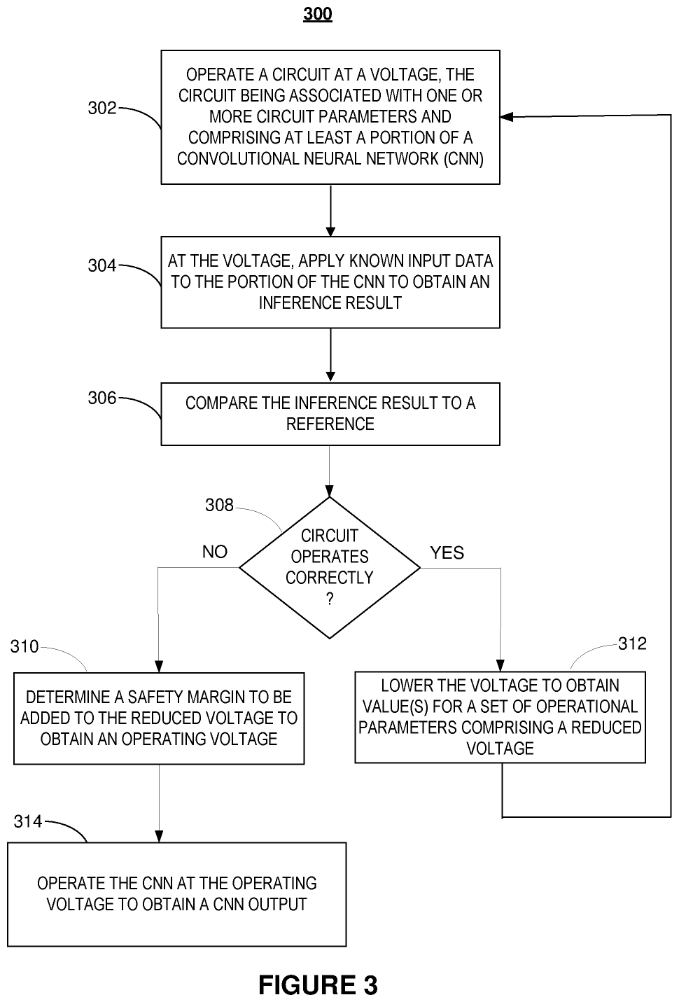

FIG. 3 is a flowchart of an illustrative process for increasing computing resource utilization in CNNs according to various embodiments of the present disclosure. In embodiments, exemplary process 300 for increasing computing capacity may begin when a circuit associated with one or more circuit parameters and comprising at least a portion of a CNN is operated (302) at a certain voltage.

A known input data may be applied (304) to the portion of the CNN, e.g., to obtain an inference result that may be compared (306) to a reference, e.g., to determine whether the circuit operates correctly.

In response to determining (308) that the circuit operates correctly, the voltage may be lowered (312) to obtain one or more values for a set of operational parameters that comprises a reduced voltage, and process 300 may return to step 302 to operate a circuit at the now reduced voltage.

In response to the determining that the circuit does not operate correctly, a safety margin may be determined (310) to be added to the reduced voltage to obtain an operating voltage.

Finally, the CNN may be operated (314) at the operating voltage to obtain a CNN output. It is noted that although the exemplary process 300 is given in the context of voltage reduction, a person of skill in the art will recognize that other means of increasing computing resource utilization may equally be used. For example, one of skill in the art will appreciate that an equivalent process may modify frequency to obtain the goal of the present disclosure.

It shall be noted that herein: (1) certain steps may optionally be performed; (2) steps may not be limited to the specific order set forth herein; (3) certain steps may be performed in different orders; and (4) certain steps may be done concurrently. In one or more embodiments, a stop condition herein may include: (1) a set number of iterations have been performed; (2) an amount of processing time has been reached; (3) convergence (e.g., the difference between consecutive iterations is less than a first threshold value); (4) divergence (e.g., the performance deteriorates); and (5) an acceptable outcome has been reached.

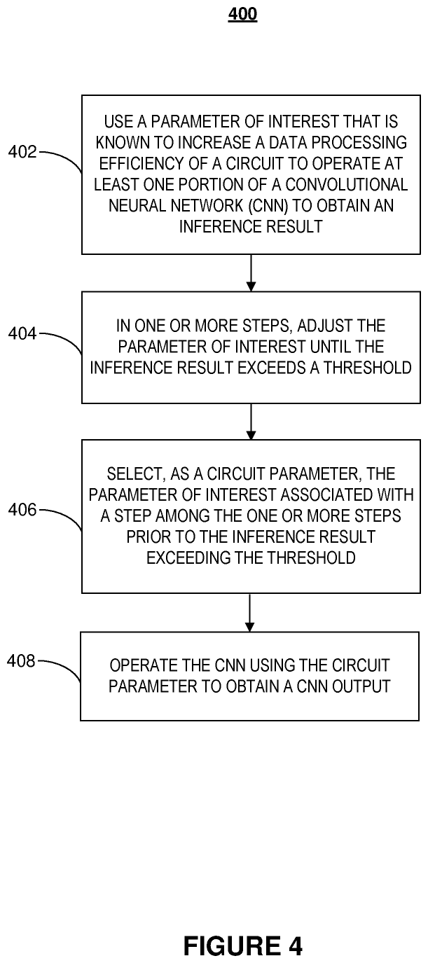

FIG. 4 is a flowchart of an alternative process for increasing computing resource utilization in CNNs according to various embodiments of the present disclosure. In embodiments, process 400 for increasing computing capacity may begin when a parameter of interest such as a clock frequency or a power supply voltage, which is known to affect the data processing efficiency of a circuit, is used to operate (402) some or all of a CNN to obtain an inference result.

That parameter of interest may be adjusted (404), in one or more steps, e.g., until the inference result exceeds a threshold, such as a threshold that renders the inference result erroneous.

The parameter of interest that is associated with a step just prior to the inference result exceeding the threshold may then be selected (406) as a circuit parameter that may be used to operate (408) the CNN at an increased data processing efficiency, e.g., to obtain an interface result that comprises the entire CNN.

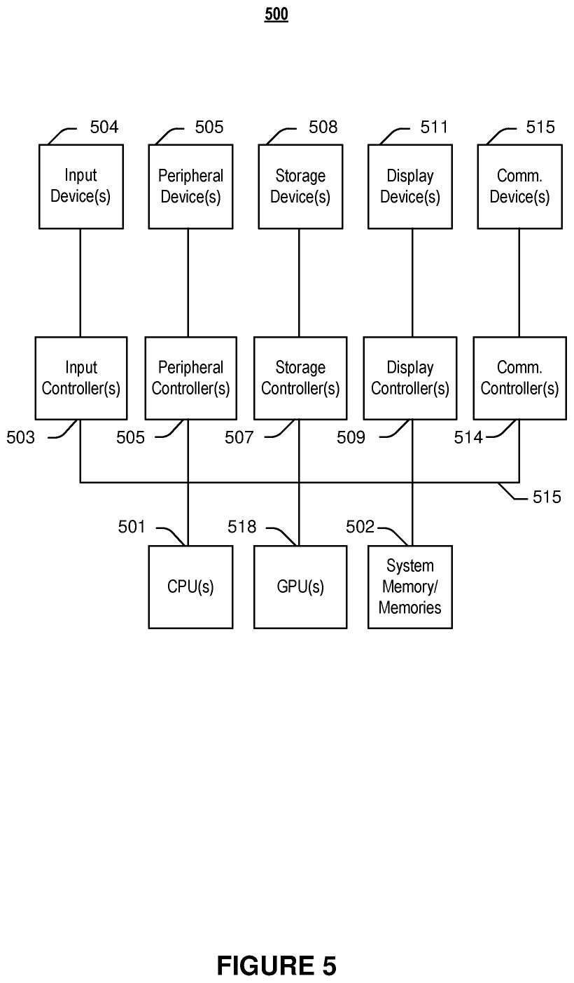

FIG. 5 depicts a simplified block diagram of an information handling system (or computing system) according to embodiments of the present disclosure. It will be understood that the functionalities shown for system 500 may operate to support various embodiments of a computing system—although it shall be understood that a computing system may be differently configured and include different components, including having fewer or more components as depicted in FIG. 5.

As illustrated in FIG. 5, the computing system 500 includes one or more CPUs 501 that provides computing resources and controls the computer. CPU 501 may be implemented with a microprocessor, or the like, and may also include one or more graphics processing units 519 and/or a floating-point coprocessor for mathematical computations. System 500 may also include a system memory 502, which may be in the form of random-access memory (RAM), read-only memory (ROM), or both.

A number of controllers and peripheral devices may also be provided, as shown in FIG. 5. An input controller 503 represents an interface to various input device(s) 504, such as a keyboard, mouse, touchscreen, and/or stylus. The computing system 500 may also include a storage controller 507 for interfacing with one or more storage devices 508 each of which includes a storage medium such as magnetic tape or disk, or an optical medium that might be used to record programs of instructions for operating systems, utilities, and applications, which may include embodiments of programs that implement various aspects of the present disclosure. Storage device(s) 506 may also be used to store processed data or data to be processed in accordance with the disclosure. The system 500 may also include a display controller 509 for providing an interface to a display device 511, which may be a cathode ray tube (CRT), a thin film transistor (TFT) display, organic light-emitting diode, electroluminescent panel, plasma panel, or other type of display. The computing system 500 may also include one or more peripheral controllers or interfaces 505 for one or more peripherals 506. Examples of peripherals may include one or more printers, scanners, input devices, output devices, sensors, and the like. A communications controller 514 may interface with one or more communication devices 515, which enables the system 500 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. Processed data and/or data to be processed in accordance with the disclosure may be communicated via the communications devices 515. For example, loader circuit 505 in FIG. 5 may receive configuration information from one or more communications devices 515 coupled to communications controller 514 via bus 516.

In the illustrated system, all major system components may connect to a bus 516, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable medium comprising, for example, magnetic media such as hard disks, floppy disks, and magnetic tape; optical media such as CD-ROMs and holographic devices; magneto-optical media; and hardware devices that are specially configured to store or to store and execute program code, such as ASICs, programmable logic devices (PLDs), flash memory devices, and ROM and RAM devices.

Aspects of the present disclosure may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that have computer code thereon for performing various computer-implemented operations. The media and computer code may be those specially designed and constructed for the purposes of the present disclosure, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as ASICs, PLDs, flash memory devices, and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A method for increasing computing resource utilization, the method comprising:
iteratively performing steps comprising:
operating a circuit at a voltage, the circuit being associated with one or more circuit parameters and comprising at least a portion of a convolutional neural network (CNN);
at the voltage, applying known input data to the portion of the CNN to obtain an inference result;
comparing the inference result to a corresponding reference result to determine whether the circuit satisfies one or more metrics;
in response to determining that the circuit satisfies the one or more metrics, lowering the voltage to obtain one or more values for a set of operational parameters that comprises a reduced voltage;
in response to the determining that the circuit does not satisfy at least some of the one or more metrics, determining a safety margin to be added to the reduced voltage to obtain an operating voltage; and
operating the CNN at the operating voltage to obtain a CNN output.

2. The method of claim 1, further comprising, in response to the circuit satisfying the one or more metrics, using a controller coupled to the circuit to cause the voltage to increase by a predetermined amount.

3. The method of claim 2, further comprising using one or more detection circuits coupled to the controller to determine one or more physical parameters.

4. The method of claim 2, further comprising using the controller to adjust the one or more circuit parameters based on at least one measured physical parameter.

5. The method of claim 4, wherein the safety margin that accounts for at least one of the one or more physical parameters or for at least one of the one or more circuit parameters.

6. The method of claim 5, further comprising, deriving the safety margin based on a statistical model that uses a distribution of samples related to the one or more physical parameters to calculate a confidence interval.

7. The method of claim 2, further comprising using the controller to adjust the voltage to the predetermined amount.

8. The method of claim 1, wherein the method for increasing computing capacity in CNNs is performed in response to a change in a target application.

9. The method of claim 3, wherein the at least the portion of the CNN represents a computational path in the circuit.

10. The method of claim 9, wherein the known input data comprises a test pattern configured to test the computational path and further comprises at least one of configuration data or weight data that have been selected to increase data processing efficiency.

11. A system for increasing computing resource utilization comprising:
a power supply having a voltage;
a circuit having one or more circuit parameters, the circuit comprising:
a memory device; and
a convolutional neural network (CNN) coupled to the memory device;
a controller being coupled to the CNN and the power supply and comprising a comparator; and
one or more sensors coupled to the circuit, the controller iteratively performs steps comprising:
at the voltage, applying known input data to at least a portion of the CNN to obtain an inference result;
using the comparator to determine whether the inference result is substantially identical to a corresponding reference result to determine whether the circuit satisfies one or more metrics;
in response to determining that the circuit satisfies the one or more metrics, lowering the voltage to obtain one or more values for a set of operational parameters that comprises a reduced voltage; and
in response to the determining that the circuit does not satisfy at least some of the one or more metrics, determining a safety margin to be added to the reduced voltage to obtain an operating voltage for the CNN that generates a CNN output.

12. The system of claim 11, wherein the controller, in response to the circuit satisfying the one or more metrics, causes the voltage to increase by a predetermined amount.

13. The system of claim 12, wherein the controller is at least one of a microcontroller or a state machine.

14. The system of claim 11, wherein the known input data comprises a test pattern configured to test the portion of the CNN and further comprises at least one of configuration data or weight data that have been selected to increase data processing efficiency.

15. The system of claim 14, wherein the test pattern is configured to detect a location of a circuit failure.

16. The system of claim 11, wherein the controller adjusts the one or more circuit parameters based on at least one measured physical parameter obtained from one or more detection circuits.

17. The system of claim 16, wherein the safety margin is derived based on a statistical model that uses a distribution of samples related to the one or more physical parameters to calculate a confidence interval.

18. The system of claim 17, wherein the one or more physical parameters comprise at least one of an environmental condition or a circuit impedance.

19. A method for increasing computing resource utilization, the method comprising:
using a parameter of interest that is known to increase a data processing efficiency of a circuit to operate at least one portion of a convolutional neural network (CNN) to obtain an inference result;
in one or more steps, adjust the parameter of interest until the inference result exceeds a threshold;
selecting, as a circuit parameter, the parameter of interest associated with a step among the one or more steps prior to the inference result exceeding the threshold; and
using the circuit parameter to operate the CNN to obtain a CNN output.

20. The method of claim 19, wherein the parameter of interest comprises at least one of a frequency or a voltage.
